(19) United States
(12) Patent Application Publication
(10) Pub. No.: US 2017/0154475 A1
(43) Pub. Date: Jun. 1, 2017

(54) SYSTEM FOR CALCULATING LIFE PERCENTAGE OF ELECTRONIC DEVICE

(71) Applicant: FLYTECH TECHNOLOGY CO., LTD, Taipei City (TW)

(72) Inventors: TAI-SENG LAM, Taipei City (TW); Chiung-Chi Lin, Taipei City (TW)

(21) Appl. No.: 15/160,312

(22) Filed: May 20, 2016

(30) Foreign Application Priority Data
Nov. 27, 2015 (TW) 104139734
Dec. 29, 2015 (TW) 104144279
Dec. 31, 2015 (TW) 104144716

(51) Int. Cl. G07C 3/00

(52) U.S. Cl. CPC G07C 3/00

(57) ABSTRACT

A method for calculating a life percentage of an electronic device is provided. Firstly, a history data of the electronic device is read. The history data contains an expected life, a spent usage time and a decay coefficient of the electronic device. Then, a life percentage value of the electronic device is generated according to the history data. Then, a residual usage time of the electronic device is calculated according to the life percentage value. Since the life percentage value is obtained according to the history data, the residual usage time of the electronic device can be calculated more accurately.

### FIELD OF THE INVENTION

The present invention relates to a method for calculating a life percentage of an electronic device, and more particularly to a system for accurately calculating a residual usage time of an electronic device.

### BACKGROUND OF THE INVENTION

With the popularity of the selling system in business, electronic devices of a point-of-sale (POS) system are used in various stores or business to manage goods purchase, goods sale, good return, fees and other information. For example, electronic devices of the POS system include a host, a monitor, a printer, and so on. In case that the electronic device needs to be replaced, the user usually notifies the engineer of the original factory to replace the components of the electronic device after the electronic device cannot be used.

For example, the electronic device for the POS system is an important business tool in the store or the business place. If the electronic device is abnormal and the abnormal situation fails to be eliminated in advance or immediately, the selling process is not smooth. Under this circumstance, the business loss increases. Therefore, it is important for the user to realize the life status of the electronic device.

Conventionally, the expected life of the electronic device is calculated according to the expected lives of the electronic components contained in the electronic device (e.g. the basic life of a battery) and the environmental conditions of the factory where the electronic components are manufactured. In fact, the use life of the electronic device is dependent on the use habit of the user, the use conditions and the operating cycles of different electronic components. Consequently, the expected life of the electronic device obtained by the conventional technology cannot be used to accurately provide the residual usage time of the electronic device.

### SUMMARY OF THE INVENTION

For solving the drawbacks of the conventional technologies, the present invention relates to a method for calculating a life percentage of an electronic device in order to accurately calculate a residual usage time of the electronic device.

In accordance with an aspect of the present invention, there is provided a method for calculating a life percentage of an electronic device. The electronic device has a history data. The method includes the following steps. Firstly, the history data is read, and a life percentage value of the electronic device is generated according to the history data. The history data contains an expected life, a spent usage time and a decay coefficient of the electronic device. Then, a residual usage time of the electronic device is calculated according to the life percentage value.

Preferably, in the step (A), the history data is read by an intelligent device that is in communication with the electronic device. When an application program installed in the intelligent device is executed, the life percentage value is obtained according to the expected life, the spent usage time and the decay coefficient, and the residual usage time of the electronic device is calculated.

In an embodiment, the history data is stored in a history parameter table of the intelligent table.

In an embodiment, the intelligent device reads the history data of the electronic device at regular time and updates the history parameter table with the read history data; or after the history data of the electronic device is updated, the intelligent device updates the history parameter table according to the updated history data.

In an embodiment, after the history parameter table is updated, the intelligent device re-calculates the life percentage value of the electronic device according to the updated history parameter table, so that the residual usage time of the electronic device is updated.

In an embodiment, the life percentage value, the spent usage time, the decay coefficient and the expected life comply with a mathematic formula:

$$Life percentage value = {\sum }_{1}^{n} \frac{spent usage time \times decay coefficient}{expected lief} ,$$

wherein n is a number of times the history parameter table has been updated.

In an embodiment, the residual usage time and the life percentage value comply with a mathematic formula:

Residual usage time=(1˜life percentage value)×expected life

In an embodiment, the decay coefficient is determined according to an operating temperature of the electronic device, an ambient temperature, an ambient humidity and/or a setting parameter of the electronic device.

In an embodiment, the expected life is an expected use life when the electronic device leaves the factory.

In an embodiment, the electronic device is the motherboard, and the spent usage time is a power-on time length of the motherboard. The decay coefficient is determined according to an operating temperature of the motherboard, an ambient temperature of the motherboard and/or a setting parameter of the motherboard. The setting parameter of the motherboard includes a voltage stability or a material conduction parameter.

In an embodiment, the electronic device is the monitor, and the spent usage time is a power-on time length of the monitor. The decay coefficient is determined according to an operating temperature of the monitor and/or a setting parameter of the monitor. The setting parameter of the monitor includes a cumulative click number of the monitor, a brightness value, a power consumption amount of the monitor, a material of the monitor or a response time.

In an embodiment, the electronic device is the hard disk drive, and the spent usage time is a power-on time length of the hard disk drive. The decay coefficient is determined according to an operating temperature of the hard disk drive and/or a setting parameter of the hard disk drive. The setting parameter of the hard disk drive includes a hard disk rotation speed, a number of times the hard disk drive is access or a power consumption amount.

In an embodiment, the electronic device is a printer, and the spent usage time is a power-on time length of the printer. The decay coefficient is determined according to an operating temperature of the printer and/or a setting parameter of the printer. The setting parameter of the printer includes a voltage specification, a printing speed, a sensor usage time or a paper thickness.

In an embodiment, the electronic device is a power supply, and the spent usage time is a power-on time length of the power supply. The decay coefficient is determined according to an operating temperature of the power supply and/or the setting parameter of the power supply. The setting parameter of the power supply includes a capacitor material specification of the power supply.

From the above descriptions, the present invention provides a method for calculating a life percentage of an electronic device. An intelligent device reads a history data of the electronic device, and calculates a life percentage value corresponding to the electronic device according to the history data. Consequently, a residual usage time of the electronic device can be acquired more accurately. Moreover, since the life percentage value is determined according to the decay coefficient of the electronic device, the important factor influencing the use life of the electronic device is taken into consideration. Consequently, the method of the present invention can facilitate the user to realize the residual usage time of the electronic device more accurately and can modify and update the residual usage time according to the decay coefficient of the electronic device at any time.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a selling system according to an embodiment of the present invention;

FIG. 2 is a schematic functional block diagram illustrating a power supply of the system of FIG. 1;

FIG. 3 is a flowchart illustrating a method for calculating the life percentage of the power supply; and

FIG. 4 is a plot illustrating the relationship between the temperature and the decay coefficient of the power supply.

### DETAILED DESCRIPTION OF THE PREFERRED EMBODIMENT

The present invention will now be described more specifically with reference to the following embodiments and accompanying drawings.

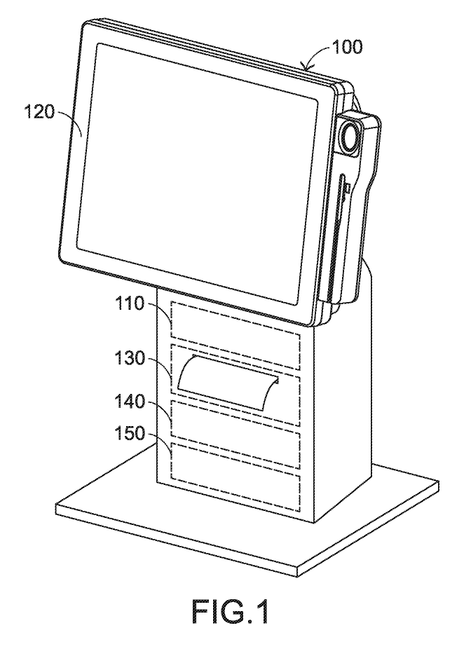

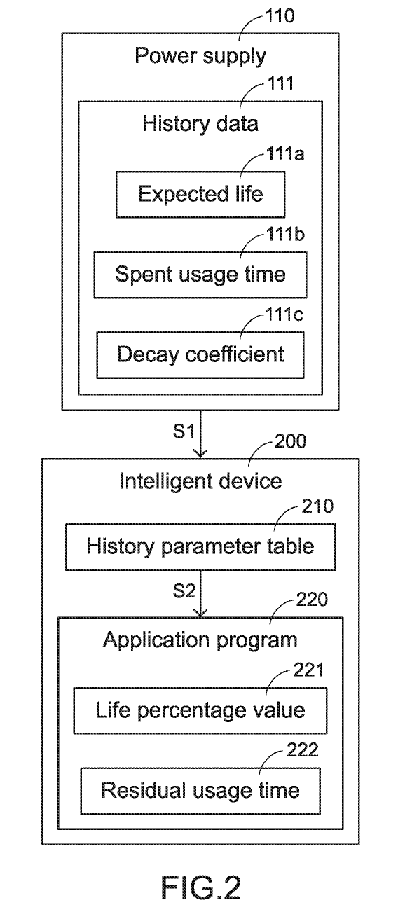

FIG. 1 schematically illustrates the architecture of a selling system according to an embodiment of the present invention. FIG. 2 is a schematic functional block diagram illustrating a power supply of the system of FIG. 1.

As shown in FIGS. 1 and 2, the selling system 100 comprises plural electronic devices. These electronic devices include a power supply 110, a monitor 120, a printer 130, a motherboard 140 and a hard disk drive 150. The power supply 110 is used to provide electricity that is required for the operation of the selling system. The monitor 120 is used for displaying the data image of the selling system 100. The printer 130 is used for generating the print data of the selling system 100. The hard disk drive 150 is used for storing the data of the selling system 100. In the selling system 100, each electronic device has its own history data. In accordance with the conventional technology, the history data of the electronic device of the selling system includes the information about the product serial number, the expected life, the maintenance record, the operating temperature and at least one setting parameter of the electronic device.

For describing the method for calculating the life percentage of the electronic device according to the present invention, the power supply 110 will be taken as an example of the electronic device. As shown in FIG. 2, the power supply 110 comprises a history data 111. The contents of the history data 111 are distinguished from the contents of the history data of the conventional technology. In addition to the contents of the history data of the conventional technology, the history data 111 of the power supply 110 further contains a spent usage time 111b and a decay coefficient 111c of the power supply 110. Moreover, an intelligent device 200 is used for calculating a residual usage time 222 of the power supply 110.

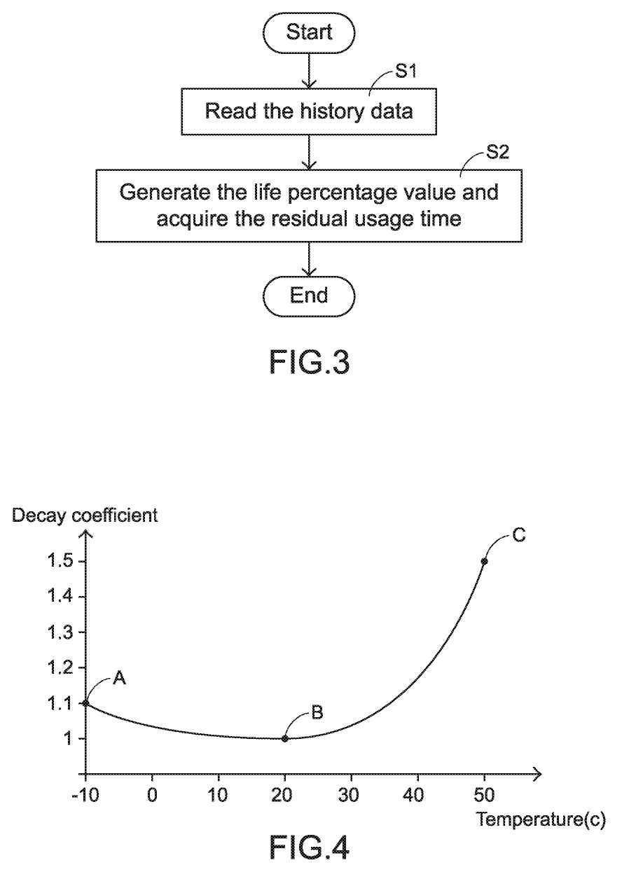

Hereinafter, a method for calculating the life percentage of the power supply will be illustrated with reference to FIG. 3. FIG. 3 is a flowchart illustrating a method for calculating the life percentage of the power supply. Please refer to FIGS. 2 and 3. Firstly, in a step 51, an application program 220 of the intelligent device 200 is executed to read the history data 111 of the power supply 110. Then, in a step S2, the expected life 111a, the spent usage time 111b and the decay coefficient 111c of the history data 111 are stored in a history parameter table 210. Then, the application program 220 calculate a life percentage value 221 of the power supply 110 according to the expected life 111a, the spent usage time 111b and the decay coefficient 111, and calculates the residual usage time 222 of the power supply 110 according to the life percentage value 221.

In an embodiment, the intelligent device 200 reads the history data of the power supply 110 according to a preset time sequence (e.g. regularly at 22:00 every day). Alternatively, in another embodiment, the intelligent device 200 automatically accesses the history data of the power supply 110 before the selling system 100 is turned off. Alternatively, while the selling system 100 updates the history data of all electronic devices, the intelligent device 200 reads the updated history data of the power supply 110. Next, the history parameter table 210 of the intelligent device 200 is updated according to the updated history data 111. After the history parameter table 210 is updated, the application program 220 re-calculate the life percentage value 221 according to the updated history parameter table 210, and updates the residual usage time 222 of the power supply 110 according to the life percentage value 221. In other words, the electronic device reads the newest history data, and then the application program 220 calculates the newest residual usage time according to the history parameter table which stores the newest history data. Consequently, the newest residual usage time can be realized by the user.

FIG. 4 is a plot illustrating the relationship between the temperature and the decay coefficient of the power supply. In an embodiment, the life percentage value 221 is calculated according to the following mathematic formula (1):

$$Life percentage value = {\sum }_{1}^{n} \frac{spent usage time \times decay coefficient}{expected lief} \qquad ( 1 )$$

In the mathematic formula (1), n is the number of times the history parameter table has been updated by the intelligent device. According to the mathematic formula (1), the summation of the product of the spent usage time of the electronic device and the decay coefficient is obtained to judge the current equivalent usage time of the electronic device.

Residual usage time=(1−life percentage value)×expected life (2)

As shown in the mathematic formula (1), the life percentage value 221 is obtained after the sum of the products of plural spent usage times 111b and plural decay coefficients 111c is divided by the expected life. The expected life is the expected use life when the power supply 110 leaves the factory. The decay coefficient 111c indicates the influence of the environmental condition of the operating electronic device on the expected life of the electronic device. For example, the decay coefficient 111c is determined according to an operating temperature of the electronic device, an ambient temperature, an ambient humidity and/or a setting parameter of the electronic device. The spent usage time is determined according to the type of the electronic device. For example, the time length that the power supply 110 is electrically powered indicates the spent usage time of the power supply 110.

Please refer to FIG. 4 again. According to the relationship between the temperature and the decay coefficient of the power supply, it is found that the decay coefficient 111c varies with the operating temperature. For example, the decay coefficient A corresponding to a low operating temperature (e.g., −10° C.) is 1.1, the decay coefficient B corresponding to an operating temperature 20° C. is 1.0, and the decay coefficient C corresponding to a high operating temperature (e.g., 50° C.) is increased to 1.5. For example, the expected life of the power supply 110 is 2000 hours, and the number of times the history parameter table 210 has been updated is 8 (n=8). Moreover, the cumulative spent usage time 111b from n=1 to n=8 is 80 hours, and the history parameter table 210 is periodically updated at a time interval of 10 hours. Moreover, the operating temperature is in the range between −10° C. and 20° C. The decay coefficients corresponding to the operating temperatures of the eight updated history parameter tables 210 are 1.08, 1.05, 1, 1.09, 1, 1.01, 1.07 and 1.075, respectively. Consequently, the life percentage value 221 of the power supply 110 is calculated by the following mathematic formula:

$$\frac{\begin{matrix}10 \times 1.08 + 10 \times 1.05 + 10 \times 1 + 10 \times 1.09 + \\ 10 \times 1 + 10 \times 1.01 + 10 \times 1.07 + 10 \times 1.075\end{matrix}}{2000} = 0.041875$$

That is, the life percentage value 221 of the power supply 110 is 0.041875.

After the life percentage value is obtained, the residual usage time is calculated according to the mathematic formula (2):

(1−0.041875)×2000=1916.25

That is, the residual usage time 222 of the power supply 110 is 1916.25 hours.

As mentioned above, the residual usage time of the power supply 110 calculated by the conventional technology is 1920 hours, which is obtained by subtracting 80 hours from 2000 hours (i.e., the expected life). On the other hand, when the actual operating condition of the power supply 110 is taken into consideration according to the present invention, the residual usage time (i.e., 1916.25) can be accurately calculated.

In the above example, the decay coefficient of the power supply is associated with the operating temperature of the power supply. It is noted that the decay coefficient of the power supply may be associated with other setting parameters. For example, in addition to the operating temperature, the decay coefficient of the power supply is associated with the electronic components of the power supply. In fact, even if the power supplies in the same batch use the capacitors with the identical capacitance, the material specifications or qualities of the capacitors are different or inconsistent because these capacitors are possibly acquired from manufacturers. Under this circumstance, the relationships between the decay coefficient and the operating temperature for the power supplies in the same batch are possibly different. In other words, different power supplies have exclusive or respective decay coefficients.

Preferably but not exclusively, the decay coefficient is determined according to the operating temperature of the electronic device, the ambient temperature, the ambient humidity and/or the setting parameter of the electronic device. Please refer to FIG. 1 again. In case that the electronic device is the monitor, the spent usage time is the power-on time length of the monitor 120 and does not include standby time of the monitor 120. The decay coefficient of the monitor 120 is determined according to the operating temperature of the monitor 120, the ambient humidity and/or the setting parameter of the monitor 120. For example, the setting parameter of the monitor 120 includes the number of times the touch screen of the monitor 120 is clicked (or touched), a brightness value, the power consumption amount of the monitor 120, the material of the monitor 120 or a response time. Moreover, the actual use life of the monitor 120 is also influenced by the color compound of the monitor 120. That is, the monitor with a different color compound has different decay coefficient.

In case that the electronic device is the motherboard 140, the spent usage time is the power-on time length of the motherboard 140. The decay coefficient of the motherboard 140 is determined according to the operating temperature of the motherboard 140, the ambient temperature and/or the setting parameter of the motherboard 140. For example, the setting parameter of the motherboard 140 includes the voltage stability or the material conduction parameter. For example, if the motherboard 140 has a lead-containing material, the use life of the motherboard 140 is influenced. That is, the motherboard with the lead-containing material and the motherboard with the lead-free material have different decay coefficients.

In case that the electronic device is the hard disk drive 150, the spent usage time is the power-on time length of the hard disk drive 150, for example the power-on time length that the hard disk drive 150 is accessed. The decay coefficient of the hard disk drive 150 is determined according to the operating temperature of the hard disk drive 150 and/or the setting parameter of the hard disk drive 150. For example, the setting parameter of the hard disk drive 150 includes a hard disk rotation speed, the number of times the hard disk drive is access or a power consumption amount. For example, the number of times the data of the hard disk drive 150 is read, the number of times the hard disk drive 150 access data and the hard disk rotation speed of the hard disk drive 150 may directly influence the use life of the hard disk drive 150.

Moreover, in case that the electronic device is the printer 130, the spent usage time is the power-on time length of the printer 130. The decay coefficient of the printer 130 is determined according to the operating temperature of the printer 130 and/or the setting parameter of the printer 130. For example, the setting parameter of the printer 130 includes a voltage specification, a printing speed, a sensor usage time or a paper thickness. For example, in the components of the printer, the usage time of the printhead and the usage time of the rubber roller are important factors that influence the actual use life of the printer 130.

In the above embodiments, the method of the present invention can accurately acquire the residual usage time of the electronic device because the spent usage time and the decay coefficient corresponding to the electronic device are taken into consideration.

From the above descriptions, the present invention provides a method for calculating a life percentage of an electronic device. An intelligent device reads a history data of the electronic device, and calculates a life percentage value corresponding to the electronic device according to the history data. Consequently, a residual usage time of the electronic device can be acquired more accurately. Moreover, since the life percentage value is determined according to the decay coefficient of the electronic device, the important factor influencing the use life of the electronic device is taken into consideration. Consequently, the method of the present invention can facilitate the user to realize the residual usage time of the electronic device more accurately and can modify and update the residual usage time according to the decay coefficient of the electronic device at any time.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for calculating a life percentage of an electronic device, the electronic device having a history data, the method comprising steps of:
(A) reading the history data, and generating a life percentage value of the electronic device according to the history data, wherein the history data contains an expected life, a spent usage time and a decay coefficient of the electronic device; and
(B) calculating a residual usage time of the electronic device according to the life percentage value.

2. The method according to claim 1, wherein in the step (A), the history data is read by an intelligent device that is in communication with the electronic device, wherein when an application program installed in the intelligent device is executed, the life percentage value is obtained according to the expected life, the spent usage time and the decay coefficient, and the residual usage time of the electronic device is calculated.

3. The method according to claim 2, wherein the history data is stored in a history parameter table of the intelligent table.

4. The method according to claim 3, wherein the intelligent device reads the history data of the electronic device at regular time and updates the history parameter table with the read history data; or after the history data of the electronic device is updated, the intelligent device updates the history parameter table according to the updated history data.

5. The method according to claim 4, wherein after the history parameter table is updated, the intelligent device re-calculates the life percentage value of the electronic device according to the updated history parameter table, so that the residual usage time of the electronic device is updated.

6. The method according to claim 4, wherein the life percentage value, the spent usage time, the decay coefficient and the expected life comply with a mathematic formula:
$$Life percentage value = {\sum }_{1}^{n} \frac{spent usage time \times decay coefficient}{expected lief} ,$$
wherein n is a number of times the history parameter table has been updated.

7. The method according to claim 1, wherein the residual usage time and the life percentage value comply with a mathematic formula:
Residual usage time=(1−life percentage value)×expected life

8. The method according to claim 1, wherein the decay coefficient is determined according to an operating temperature of the electronic device, an ambient temperature, an ambient humidity and/or a setting parameter of the electronic device.

9. The method according to claim 1, wherein the expected life is an expected use life when the electronic device leaves the factory.

10. The method according to claim 8, wherein the electronic device is the motherboard, and the spent usage time is a power-on time length of the motherboard, wherein the decay coefficient is determined according to an operating temperature of the motherboard, an ambient temperature of the motherboard and/or a setting parameter of the motherboard, wherein the setting parameter of the motherboard includes a voltage stability or a material conduction parameter.

11. The method according to claim 8, wherein the electronic device is the monitor, and the spent usage time is a power-on time length of the monitor, wherein the decay coefficient is determined according to an operating temperature of the monitor and/or a setting parameter of the monitor, wherein the setting parameter of the monitor includes a cumulative click number of the monitor, a brightness value, a power consumption amount of the monitor, a material of the monitor or a response time.

12. The method according to claim 8, wherein the electronic device is the hard disk drive, and the spent usage time is a power-on time length of the hard disk drive, wherein the decay coefficient is determined according to an operating temperature of the hard disk drive and/or a setting parameter of the hard disk drive, wherein the setting parameter of the hard disk drive includes a hard disk rotation speed, a number of times the hard disk drive is access or a power consumption amount.

13. The method according to claim 8, wherein the electronic device is a printer, and the spent usage time is a power-on time length of the printer, wherein the decay coefficient is determined according to an operating temperature of the printer and/or a setting parameter of the printer, wherein the setting parameter of the printer includes a voltage specification, a printing speed, a sensor usage time or a paper thickness.

14. The method according to claim 8, wherein the electronic device is a power supply, and the spent usage time is a power-on time length of the power supply, wherein the decay coefficient is determined according to an operating temperature of the power supply and/or the setting parameter of the power supply, wherein the setting parameter of the power supply includes a capacitor material specification of the power supply.
